(19) United States
(12) Patent Application Publication
(10) Pub. No.: US 2025/0108611 A1
(43) Pub. Date: Apr. 3, 2025

(54) LIQUID EJECTING APPARATUS, CONTROLLER, CONTROL METHOD AND NON-TRANSITORY COMPUTER READABLE MEDIUM STORING PROGRAM FOR CONTROLLING LIQUID EJECTING APPARATUS

(71) Applicant: BROTHER KOGYO KABUSHIKI KAISHA, Nagoya (JP)

(72) Inventor: Satoru ARAKANE, Nagoya (JP)

(73) Assignee: BROTHER KOGYO KABUSHIKI KAISHA, Nagoya (JP)

(21) Appl. No.: 18/895,784

(22) Filed: Sep. 25, 2024

(30) Foreign Application Priority Data
Sep. 28, 2023 (JP) 2023-168438

(51) Int. Cl. B41J 2/045

(52) U.S. Cl. CPC B41J 2/04581

(57) ABSTRACT

A liquid ejecting apparatus including a head, a moving mechanism and a controller is provided. The controller is configured to execute causing the head to not eject liquid in an acceleration section and to eject liquid in a constant speed section during a second movement, in a case where it is determined that a stop position in a first movement is not on one side of a scanning direction relative to a target position. The controller is configured to execute causing the head to eject liquid in the acceleration section and the constant speed section during the second movement, in a case where it is determined that the stop position in the first movement is on the one side of the scanning direction relative to the target position.

### REFERENCE TO RELATED APPLICATIONS

This application claims priority from Japanese Patent Application No. 2023-168438 filed on Sep. 28, 2023. The entire content of the priority application is incorporated herein by reference.

### BACKGROUND ART

In a known liquid ejecting apparatus, acceleration printing is performed in the acceleration area, from the point where the carriage with the head is being accelerated to the point where the carriage reaches a constant speed. Then, constant speed printing is performed in the constant speed area, where the carriage moves at a constant speed at the target speed. Furthermore, printing is stopped in the deceleration area, from constant speed to a stop.

### SUMMARY

In the following explanation, an acceleration area, a constant speed area, and a deceleration area are referred to as an acceleration section, a constant speed section, and a deceleration section, respectively. The above liquid ejecting apparatus performs printing in the acceleration and constant speed areas, i.e., it ejects the liquid. This configuration is advantageous in that it can achieve high-speed recording. However, the landing position of the liquid ejected in the acceleration area tends to deviate from the desired position. Therefore, the above configuration tends to degrade the image quality more than a configuration that performs printing only in the constant speed area.

In the above liquid ejecting apparatus, the first movement is to move the head from one side to the other in the scanning direction, and the second movement is to move the head from the other side to the one side in the scanning direction. In the first movement, the head may stop before the target position at the end of the deceleration area. This can occur due to deterioration of the moving mechanism (motor, tube, etc.). In this case, it is conceivable that the second movement would be started after the head is moved to the target position. However, in this case, time is required to move the head to the target position. Therefore, it becomes difficult to achieve high-speed recording.

The purpose of the present disclosure is to provide a technology that controls the head stop position so as to control the deterioration of image quality and achieve high-speed recording at the same time.

According to the present disclosure, a liquid ejecting apparatus including a head, a moving mechanism and a controller is provided. The head includes a nozzle. The moving mechanism is configured to perform a first movement that moves the head from one side of a scanning direction to another side of the scanning direction, and a second movement that moves the head from the another side of the scanning direction to the one side of the scanning direction. The first movement and the second movement each include moving the head over an acceleration section in which the speed of the head increases from zero to a predetermined speed, a constant speed section in which the speed of the head is maintained at the predetermined speed after the acceleration section, and a deceleration section in which the speed of the head decreases from the predetermined speed to zero after the constant speed section. The controller is configured to execute: causing the moving mechanism to perform the first movement; determining whether or not a stop position where the head stops at an end of the deceleration section in the first movement is on the one side of the scanning direction relative to a target position; causing the moving mechanism to execute the second movement and, in the second movement, and causing the head to not eject liquid from the nozzle in the acceleration section and to eject the liquid from the nozzle in the constant speed section, in a case where it is determined that the stop position is not on the one side of the scanning direction relative to the target position; and causing the moving mechanism to execute the second movement and, in the second movement, and causing the head to eject the liquid from the nozzle in the acceleration section and the constant speed section, in a case where it is determined that the stop position is on the one side of the scanning direction relative to the target position.

According to the present disclosure, in the case where the head does not stop before the target position in the first movement, the head is controlled to eject the liquid in the constant speed section in the next second movement. In the case where the head does not stop before the target position, it corresponds to one side of the scanning direction. In other words, in the case where the head stops at the target position or on the another side of the scanning direction from the target position, the head is controlled to eject the liquid at the constant speed section in the second movement. This helps to control any deterioration in image quality that may occur when ejecting the liquid in the acceleration section and allows good image quality to be obtained. On the other hand, in the case where the head stops before the target position (i.e., on one side of the scanning direction) in the first movement, the head starts the second movement from the position where the head stopped. In other words, the second movement does not start after the head has moved to the target position, but starts from the position where it stopped. The head then ejects the liquid in the acceleration section and the constant speed section. This omits the time required for the head to move to the target position. This contributes to achieving high-speed recording.

In other words, this disclosure contributes to controlling the deterioration of image quality and achieving high-speed recording by controlling in accordance with the position where the head stops. This helps to control any deterioration in image quality that may occur when ejecting the liquid in the acceleration section, and allows good image quality to be obtained. On the other hand, in the case where the head stops before the target position (i.e., on one side of the scanning direction) in the first movement, subsequent second movement starts from the stop position. In other words, the second movement is not started after the head has moved to the target position, but is started from the stop position. The head then ejects the liquid in the acceleration section and the constant speed section. This omits the time required for the head to move to the target position. This contributes to achieving high-speed recording. In other words, this disclosure contributes to controlling the deterioration of image quality and achieving high-speed recording by controlling in accordance with the position where the head stops.

### BRIEF DESCRIPTION OF DRAWINGS

FIG. 1: is a plan view showing the overall configuration of the printer.

FIG. 2: is a cross-sectional view of the head shown in FIG. 1.

FIG. 3: is a block diagram indicating the electrical configuration of the printer shown in FIG. 1.

FIG. 4: is a schematic diagram indicating the movement of the head in the printer shown in FIG. 1.

FIG. 5 is a flowchart indicating the program executed by the controller of the printer depicted in FIG. 1.

FIG. 6 is a flowchart indicating one of the subroutines of the recording process in FIG. 5.

FIG. 7 is a flowchart indicating one of the subroutines of the recording process in FIG. 5.

FIG. 8 is a flowchart indicating one of the subroutines of the recording process in FIG. 5.

FIG. 9A and FIG. 9B depict a flowchart indicating one of the subroutines of the recording process in FIG. 5.

### DESCRIPTION

In the following explanation, X and Y directions are horizontal directions, and Z direction is a vertical direction. The X, Y, and Z directions are mutually orthogonal. The Y direction corresponds to the “scanning direction” of this disclosure.

### First Embodiment

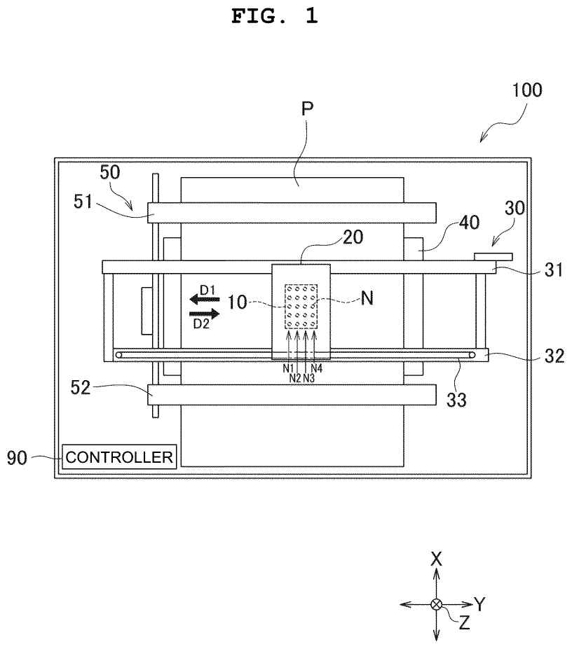

The printer 100 depicted in FIG. 1 is the first embodiment of the “liquid ejecting apparatus” according to the present disclosure. The printer 100 includes a head 10 including a plurality of nozzles N, a carriage 20 which holds the head 10, a moving mechanism 30 which moves the carriage 20 and the head 10, a platen 40 which supports the medium M from below, a conveyor 50 which conveys the medium M, and a controller unit 90.

The plurality of nozzles N is arranged to form four nozzle rows N1 to N4 aligned in the Y direction. Each nozzle row N1 to N4 includes a plurality of nozzles N arranged in the X direction. The nozzles N included in the nozzle rows N1 to N4 are arranged so that the nozzles overlap each other in the Y direction. The nozzles N included in the four nozzle rows N1 to N4 is configured to eject black ink respectively.

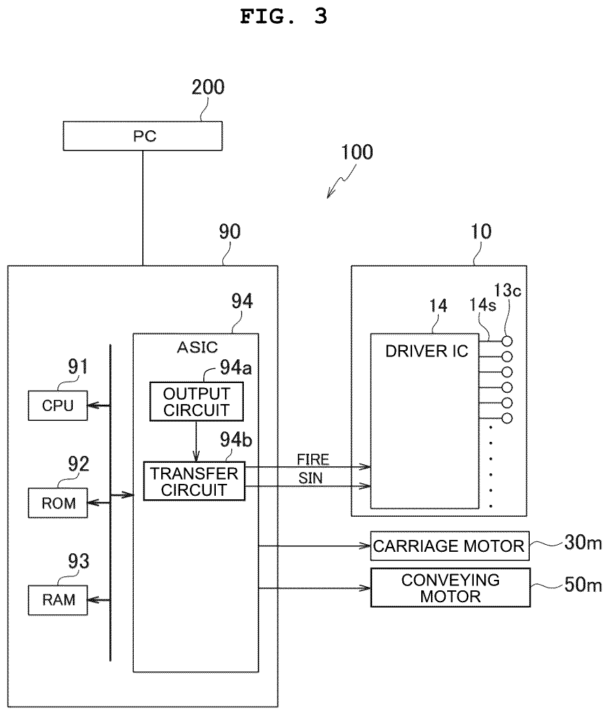

The moving mechanism 30 includes a pair of guides 31, 32 that support the carriage 20 and a belt 33 connected to the carriage 20. The guides 31, 32 and the belt 33 extend in the Y direction. When the carriage motor 30m (see FIG. 3) is driven under the control of the controller unit 90, the belt 33 moves, and the carriage 20 and the head 10 move in the Y direction along the guides 31 and 32. In other words, the moving mechanism 30 performs a first movement that moves the head 10 from one side to the other (in the D1 direction depicted in FIG. 1) in the Y direction. Furthermore, the moving mechanism 30 executes a second movement that moves the head 10 from one side to the other side (in the D2 direction depicted in FIG. 1).

The platen 40 is located below the carriage 20 and the head 10. The medium M is supported on an upper surface of the platen 40.

The conveyor 50 includes two roller pairs 51 and 52. The head 10, the carriage 20, and the platen 40 are located between the roller pairs 51 and 52 in the X direction. When the conveying motor 50m (see FIG. 3) is driven under the control of the controller unit 90, the roller pairs 51 and 52 rotate while holding the medium M. This causes the medium M to be conveyed in the X direction.

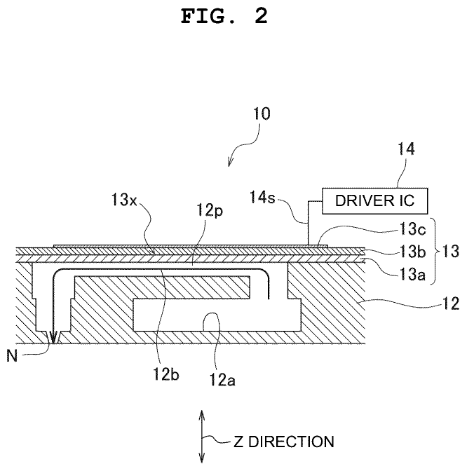

As depicted in FIG. 2, the head 10 includes a flow channel unit 12 and an actuator unit 13.

The plurality of nozzles N (see FIG. 1) is open on the lower surface of the flow channel unit 12. The inside of the flow channel unit 12 has a manifold 12a connected to the ink tank (not depicted) and a plurality of individual channels 12b corresponding to the nozzles N. The individual channels 12b are the channels that lead from the outlet of the manifold 12a to the nozzles N via a plurality of pressure chambers 12p. The plurality of pressure chambers 12p is opened on the upper surface of the flow channel unit 12.

The actuator unit 13 includes a metal vibration plate 13a, a piezoelectric layer 13b, and a plurality of individual electrodes 13c. The metal vibration plate 13a is located on the upper surface of the flow channel unit 12, covering the plurality of pressure chambers 12p. The piezoelectric layer 13b is located on the upper surface of the vibration plate 13a. The plurality of individual electrodes 13c is located on the upper surface of the piezoelectric layer 13b, facing each of the plurality of pressure chambers 12p.

The vibration plate 13a and the plurality of individual electrodes 13c are electrically connected to the driver IC 14. The driver IC 14 maintains the potential of the vibration plate 13a at the ground potential. The driver IC 14 changes the potential of the individual electrodes 13c. Specifically, the driver IC 14 generates a driving signal based on the control signals (waveform signal FIRE and selection signal SIN) from the controller unit 90, and supplies the driving signal to the individual electrodes 13c via the signal line 14s. As a result, the potential of the individual electrodes 13c changes between the predetermined driving potential (VDD) and the ground potential (0V). At this time, the part, of the vibration plate 13a and piezoelectric layer 13b, (actuator 13x) sandwiched between the individual electrodes 13c and the pressure chambers 12p deforms. At this time, the volume of the pressure chamber 12p changes, and pressure is applied to the ink in the pressure chamber 12p. Then, ink is ejected from the nozzle N. The actuator 13x is provided for each of the individual electrodes 13c (i.e., for each of the nozzles N). The actuator 13x is independently deformable in accordance with the potential supplied to the relevant individual electrode 13c.

As depicted in FIG. 3, the controller unit 90 includes a central processing unit 91 (CPU 91), a read-only memory 92 (ROM 92), a random-access memory 93 (RAM 93), and an application specific integrated circuit 94 (an ASIC 94). Processors such as the CPU 91 and ASIC 94 correspond to the “controller” of the present disclosure.

The ROM 92 stores the programs and data used by the CPU 91 and the ASIC 94 to perform various types of control. The RAM 93 temporarily stores the data used by the CPU 91 and the ASIC 94 when the programs are executed. The controller unit 90 is connected to a PC (personal computer) 200 in a way that allows communication. The controller unit 90 executes recording process based on image data using the CPU 91 and the ASIC 94, or based on recording commands received from the PC 200.

In the recording process, the ASIC 94 controls the head 10 and the conveyor 50 based on the recording commands received from the PC 200, in accordance with the commands from the CPU 91, causing the conveying and scanning operations to be performed alternately. In the conveying operation, the ASIC 94 drives the driver IC 14, the carriage motor 30m, and the conveying motor 50m. This causes the conveyor 50 to convey the medium M in a certain distance in the X direction. In the scanning operation, the ASIC 94 drives the driver IC 14 and the carriage motor 30m. This causes the carriage 20 and head 10 to move in the Y direction while ink is ejected from the nozzle N. This causes dots of ink to be formed on the medium M, and an image is recorded.

The scanning operation includes a moving operation that moves the carriage 20 and the head 10 in the Y direction, and an ejecting operation in which the ink is ejected from the nozzles N. The moving operation includes a first moving operation in the D1 direction and a second moving operation in the D2 direction (see FIG. 1).

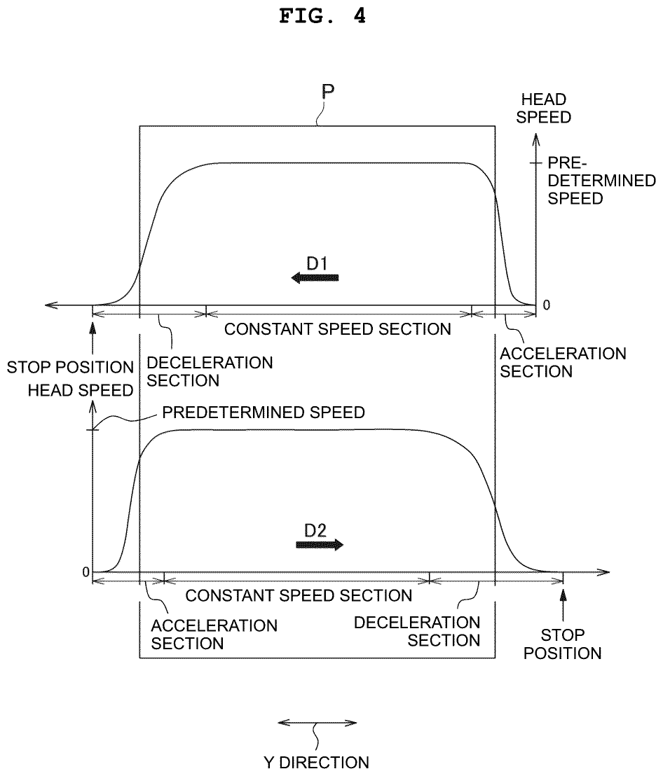

The first movement and the second movement are movements that move the head 10 over the acceleration section, the constant speed section, and the deceleration section (see FIG. 4). The acceleration section is the section in which the speed of the head 10 increases from zero to a predetermined speed. The constant speed section is the section in which the speed of the head 10 is maintained at the predetermined speed after the acceleration section. The deceleration section is the section in which the speed of the head 10 decreases from the predetermined speed to zero after the constant speed section.

As depicted in FIG. 3, the ASIC 94 includes an output circuit 94a and a transfer circuit 94b.

The output circuit 94a generates the waveform signal FIRE and the selection signal SIN, and outputs these signals to the transfer circuit 94b each time a recording cycle is completed. A recording cycle is the time required for the medium M to move relative to the head 10 by a unit distance corresponding to the resolution of the image formed on the medium M, and corresponds to one pixel.

The waveform signal FIRE is a serial signal that serializes the four pieces of ejection data. The ejection data is data for ejecting ink from the nozzles N and indicates the potential of the individual electrode 13c. The four pieces of ejection data differ from each other in terms of the number of pulses, the width of the pulses, etc., which change the potential of the individual electrode 13c between the ground potential (0V) and the drive potential (VDD) within one recording cycle. As a result, the four types of ejection data have different amounts of ink ejected from nozzle N within one recording cycle: “zero (no ejection: 0 pl)”, “small (5 pl)”, “medium (10 pl)” and “large (40 pl)”.

The selection signal SIN is a serial signal that includes selection data for selecting one of the four pieces of the ejection data. The selection signal SIN is generated for each actuator 13x and each recording cycle based on the image data contained in the recording command.

The transfer circuit 94b transfers the waveform signal FIRE and the selection signal SIN received from the output circuit 94a to the driver IC 14. The transfer circuit 94b incorporates an LVDS (Low Voltage Differential Signaling) driver corresponding to each of the above signals and transfers each signal to the driver IC 14 as a pulse-type differential signal.

In the recording process, the ASIC 94 controls the driver IC 14 to generate the driving signal for each pixel based on the waveform signal FIRE and the selection signal SIN. The ASIC 94 then controls the driver IC 14 to supply the driving signal to the individual electrodes 13c via the signal line 14s. In this way, the ASIC 94 causes ink to be ejected from each of the plurality of nozzles N in the amount corresponding to the ejection data selected from among the four pieces of ejection data for each pixel toward the medium M.

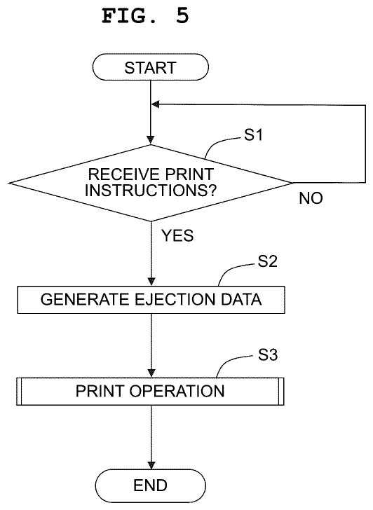

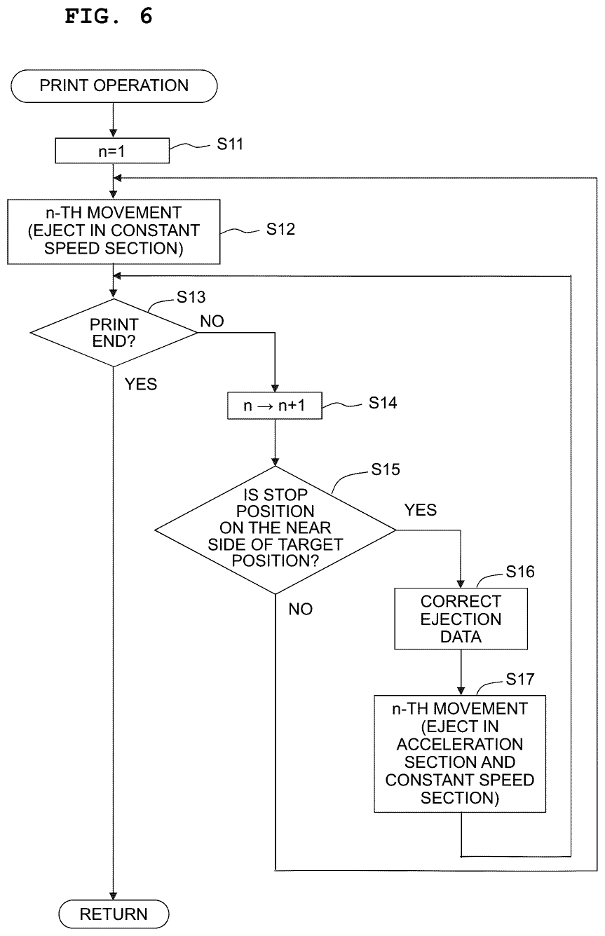

Next, referring to FIGS. 5 and 6, a program executed by the controller unit 90 will be explained.

The CPU 91 of the controller unit 90 first determines whether or not a recording instruction has been received from the PC 200 (S1).

In the case where the CPU 91 determines that the record instruction has not been received (S1: NO), repeats the process in step S1.

In the case where the CPU 91 determines that the recording instruction has been received (S1: YES), the CPU 91 causes the ASIC 94 to generate the selection signal SIN for each actuator 13x and each recording cycle based on the image data included in the recording instruction received in step S1 (S2). The selection signal SIN is a signal for selecting one piece of ejection data from among the four pieces of ejection data that match the relevant conditions. The process in step S2 corresponds to the “generation process” for generating ejection data based on image data.

After completing process in step S2, the CPU 91 executes the recording process (S3) and then terminates the program.

In the record process (S3), the CPU 91 first sets n=1, as depicted in FIG. 6 (S11).

After completing process in step S11, the CPU 91 causes the moving mechanism 30 to execute the nth movement. At the same time, in the nth movement, the CPU 91 causes the head 10 to perform the ejection operation, in which the ink is ejected from the nozzle N in the constant speed section (see FIG. 4) (S12: movement process). In step S12, the CPU 91 does not cause the head 10 to eject ink from the nozzle N in the acceleration section and the deceleration section.

After completing process in step S12, the CPU 91 determines whether or not the recording process based on the recording instruction received in step S1 has been completed (S13). The CPU 91 determines that the recording process has been completed in the case where n=N (N: the number of movement operations determined based on the image data) is satisfied.

In the case where the CPU 91 determines that the recording process is completed (S13: YES), terminates the relevant routine.

In the case where the CPU 91 determines that the recording process has not been completed (S13: NO), n is set to n+1 (S14).

After completing process in step S14, the CPU 91 determines whether or not the stop position (see FIG. 4) where the head 10 stops at the end of the deceleration section in the nth movement in step S12 has reached the target position (S15: first determination process). For example, in the case where the nth movement is the first movement (the movement that moves the head 10 from one side to the other in the Y direction), the CPU 91 determines in step S15 whether the above-mentioned stop position is on one side of the target position in the Y direction.

In step S15, the CPU 91 identifies the stop position described above based on the signal from the encoder attached to the carriage motor 30m.

The target position is held in the ROM 92. For example, in the case where the nth movement is the first movement (the movement that moves the head 10 from one side to the other side in the Y direction), the target position is the position that is a distance away from the end of the constant speed section towards the other side in the Y direction, and is the position that is required for the speed of the head 10 to decrease from the specified speed to zero.

In the case where the CPU 91 determines that the stop position was before the target position, in other words, where the CPU 91 determines that the stop position did not reach the target position (S15: YES), the ejection data in the acceleration section of the nth movement is corrected (S16: correction process) in the direction where the landing positions of the ink ejected from the nozzle N become equidistant in the Y direction. Such correction is performed according to the difference between the speed of the head 10 in the acceleration section of the nth movement and the specified speed. In step S16, the CPU 91 corrects the selection signal SIN generated in step S2.

After completing process in step S16, the CPU 91 causes the moving mechanism 30 to execute the nth movement. At the same time, in the nth movement, the CPU 91 causes the head 10 to perform a ejection operation to eject ink from the nozzle N in the acceleration section and the constant speed section (see FIG. 4) (S17). In step S17, the CPU 91 does not cause the head 10 to eject ink from the nozzle N in the deceleration section. In the acceleration section, the CPU 91 causes the head 10 to eject ink from the nozzle N based on the ejection data corrected in step S16. In the constant speed section, the CPU 91 causes the head 10 to eject ink from the nozzle N based on the ejection data generated in step S2.

After completing process in step S17, the CPU 91 returns to process in step S13.

In the case where the CPU 91 determines that the stop position has not yet reached the target position (S15: NO), the CPU 91 returns to the process in step S12. In other words, the CPU 91 causes the moving mechanism 30 to execute the nth movement. At the same time, in the nth movement, the CPU 91 causes the head 10 to perform the ejection operation, in which ink is ejected from the nozzle N in the constant speed section (see FIG. 4) (S12: movement process). In step S12, the CPU 91 does not cause the head 10 to eject ink from the nozzle N in the acceleration section and the deceleration section. During the constant speed section, the CPU 91 causes the head 10 to eject ink from the nozzle N based on the ejection data generated in step S2.

As described above, according to this embodiment, in the case where the CPU 91 determines that the stop position of the head 10 in the first movement is not on one side of the scanning direction with respect to the target position (i.e., not before the target position) (S15: NO), in the second movement, the head 10 is not caused to eject ink from the nozzle N in the acceleration section, and the head 10 is caused to eject ink from the nozzle N in the constant speed section (S12). This helps to control the deterioration of image quality that may occur when the head 10 is caused to eject ink in the acceleration section, and contributes to obtaining good image quality. On the other hand, in the case where it is determined that the stop position of the head 10 in the first movement is on one side of the target position in the scanning direction (i.e., before the target position) (S15: YES), the CPU 91 starts the second movement from the stop position in this case, and causes the head 10 to eject ink in the acceleration section and the constant speed section (S17). This allows the time required to move the head 10 to the target position to be omitted, and allows high-speed recording to be achieved. In other words, according to this embodiment, it is possible to achieve both high-speed recording and controlling the deterioration of image quality according to control of the stop position of the head 10.

Before ejecting ink from nozzle N in the acceleration section and the constant speed section of the second movement, that is, before step S17, the CPU 91 corrects the ejection data for the acceleration section of the second movement (S16: correction process). The CPU 91 corrects the ejection data so that the landing position of the ink ejected from the nozzle N lies in a direction where the distances between the landing positions are equal in the Y direction, according to the difference between the speed of the head 10 in the acceleration section of the second movement and the predetermined speed. This helps to control the deterioration in image quality that can occur in the case where ink is ejected in the acceleration section of the second movement.

In the case where the CPU 91 determines that the stop position of the head 10 in the first movement is not on one side of the target position in the scanning direction (i.e., the stop position is not before the target position) (S15: NO), the CPU 91 does not cause the head 10 to eject ink from the nozzle N in the deceleration section in the second movement (S12, S17). In addition, in the case where the CPU 91 determines that the stop position of the head 10 in the first movement is on one side of the target position in the scanning direction (i.e., the stop position is before the target position) (S15: YES), the CPU 91 also does not cause the head 10 to eject ink from the nozzle N in the deceleration section in the second movement (S12, S17). The landing positions of the ink ejected in the deceleration section and the acceleration section are both likely to be off from the ideal position. According to this embodiment, by not ejecting ink from the head 10 in the deceleration section, it is possible to control the deterioration of image quality.

### Second Embodiment

Next, the second embodiment of the present disclosure will be explained.

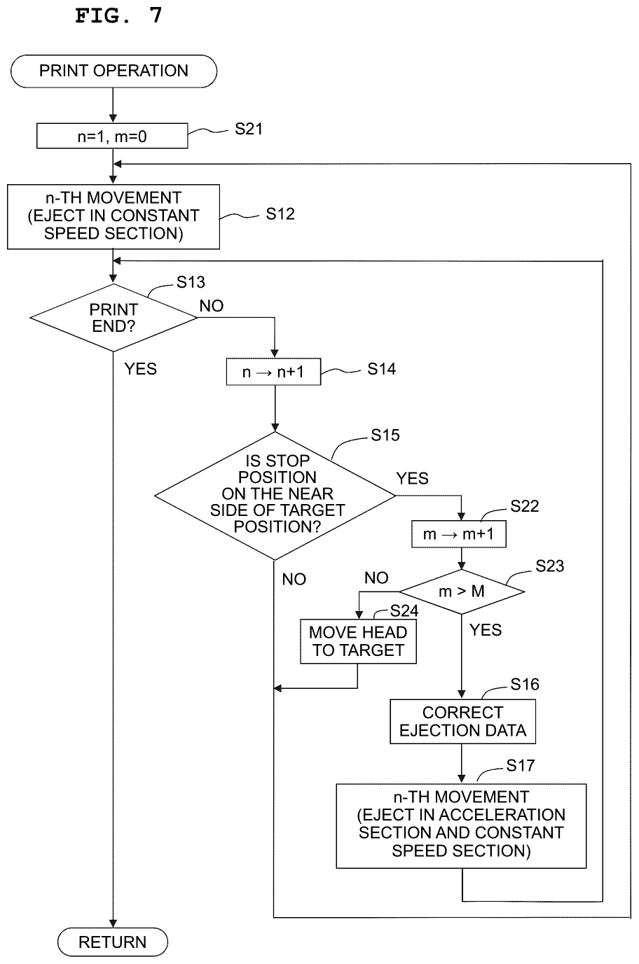

The second embodiment (see FIG. 7) differs from the first embodiment (see FIG. 6) in the content of the recording process. Apart from this point, the second embodiment is the same as the first embodiment. In FIG. 7, the same step numbers are used for processes that are the same as those in FIG. 6.

In the second embodiment, in the recording process, the CPU 91 first sets n=1 and m=0 (S21).

After step S21, the CPU 91 executes steps S12 to S15 in the same way as in the first embodiment.

In the case where CPU 91 determines that the stop position is in front of the target position (S15: YES), CPU 91 sets m=m+1 (S22).

After step S22, the CPU 91 determines whether or not m exceeds M (step S23: second determination process). Here, “m” represents the number of times it was determined in step S15 that the stop position was before the target position (step S15: YES), and is held in RAM 93. “M” represents a predetermined number (a natural number), and is held in ROM 92.

In the case where the CPU 91 determines that m exceeds M (S23: YES), the CPU 91 executes the same process in S16 and S17 as in the first embodiment.

In the case where the CPU 91 determines that m does not exceed M (S23: NO), the CPU 91 causes the moving mechanism 30 to move the head 10 to the target position (S24), and then returns to step S12.

As described above, in the second embodiment, in the case where the CPU 91 determines that the stop position of the head 10 in the first movement is on one side of the target position in the scanning direction (i.e., before the target position) (S15: YES), the CPU 91 further determines whether or not m exceeds M (whether or not the predetermined condition is satisfied) (S23: second determination process). In the case where the CPU 91 determines that m exceeds M (the predetermined condition is satisfied) (S23: YES), the CPU 91 causes the head to eject the ink in the acceleration section and the constant speed section (S17). In other words, the CPU 91 does not cause the head 10 to eject the ink in the acceleration section and the constant speed section without exception in the case where the CPU 91 determines that the stop position of the head 10 is before the target position (S15: YES). Furthermore, in the case where the specified condition that m exceeds M is satisfied, the CPU 91 causes the head 10 to eject ink in the acceleration section and the constant speed section. This allows a balance to be struck between controlling the deterioration of image quality and high-speed recording according to the situation.

In the case where the CPU 91 determines that the stop position of the head 10 in the first movement is before the target position (S15: YES) and also determines that m does not exceed M (the predetermined condition is not satisfied) (S23: NO), the second movement is started after moving the head 10 to the target position (after S24). At the same time, the CPU 91 causes the head 10 to eject ink in the constant speed section (S12). This helps to control the deterioration of image quality that can occur when ejecting ink in the acceleration section, and enables good image quality to be obtained.

The predetermined condition is that the number of times m that the head 10 stops before the target position exceeds the predetermined number M. In the case where the CPU 91 determines that m exceeds M (S23: YES), the second movement is not started after moving the head 10 to the target position (S24), but is started from the relevant stop position, and ink is ejected in the acceleration section and the constant speed section (S17). This makes it feasible to achieve high-speed recording.

### Third Embodiment

Next, the third embodiment of the present disclosure will be explained.

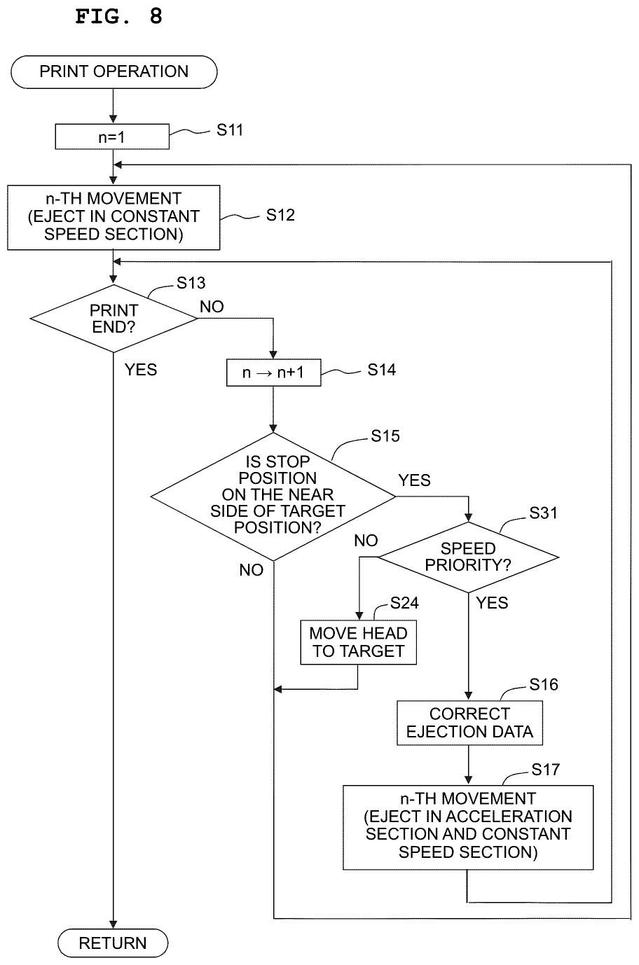

The content of the recording process in the third embodiment (see FIG. 8) differs from that of the first embodiment (see FIG. 6). Apart from this point, the third embodiment is the same as the first embodiment. In FIG. 8, the same step numbers are used for processes that are the same as those in FIGS. 6 and 7.

In the third embodiment, in the recording process, the CPU 91 first executes the same processes in steps S11 to S15 as in the first embodiment.

In the case where the CPU 91 determines that the stop position is before the target position (S15: YES), the CPU 91 determines whether or not the instruction by the user included in the recording instruction received in step S1 is a speed-priority instruction (S31).

The recording instruction may include a user instruction. This instruction is either a “speed priority” instruction (first instruction) or a “picture quality priority” instruction (second instruction). In other words, when the recording instruction is received, the CPU 91 executes an acceptance process that accepts the user instruction (either the speed priority instruction or the picture quality priority instruction) included in the recording instruction.

In the case where the CPU 91 determines that the user instruction is the speed-priority instruction (S31: YES), the CPU 91 executes the same processes in steps S16 and S17 as in the first embodiment.

In the case where the CPU 91 determines that the user instruction is not the speed-priority instruction (i.e., the user instruction is the picture quality-priority instruction) (S31: NO), the CPU 91 causes the moving mechanism 30 to move the head 10 to the target position (S24), and then returns to step S12.

As described above, in the third embodiment, the predetermined condition is that the speed-priority instruction (first instruction) is accepted in the reception process. The CPU 91 selects either controlling for high-speed recording (S17) or controlling for image quality deterioration (S24→S12) according to the instruction by the user. This facilitates recording as desired by the user.

### Fourth Embodiment

Next, the fourth embodiment of the present disclosure will be explained.

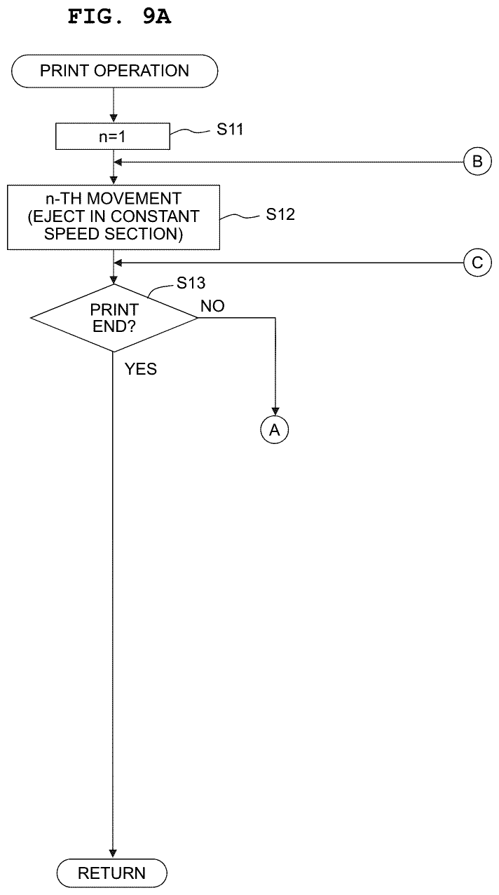

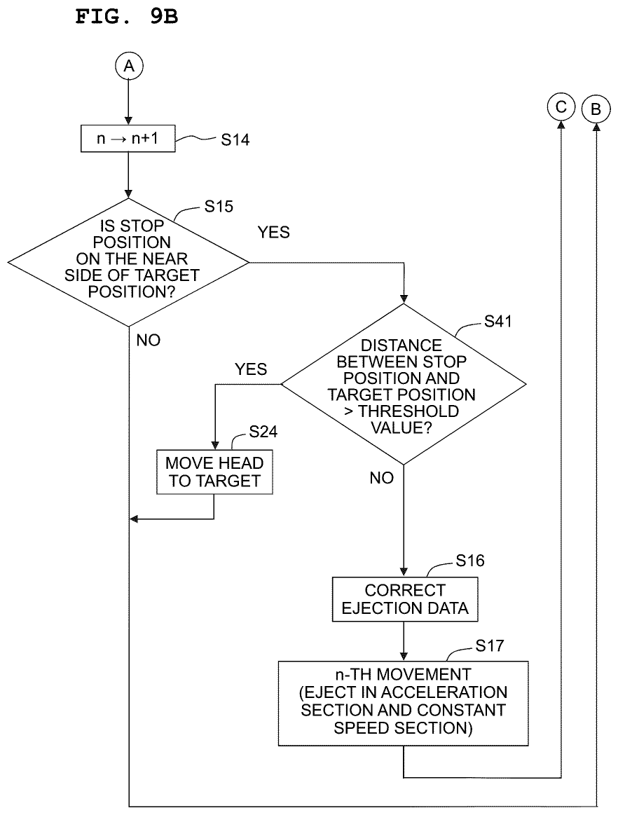

The content of the recording process in the fourth embodiment (see FIGS. 9A and 9B) differs from that of the first embodiment (see FIG. 6). Apart from this point, the fourth embodiment is the same as the first embodiment. In FIGS. 9A and 9B, the same step numbers are used for processes that are common to FIGS. 6 and 7.

In the fourth embodiment, in the recording process, the CPU 91 first executes the same processes in steps S11 to S15 as in the first embodiment.

In the case where the CPU 91 determines that the stop position is before the target position (S15: YES), the CPU 91 determines whether or not the distance between the stop position and the target position exceeds the threshold value (S41).

In the case where the CPU 91 determines that the distance between the stop position and the target position does not exceed the threshold value (S41: NO), the CPU 91 executes the same processes in steps S16 and S17 as in the first embodiment.

In the case where the CPU 91 determines that the distance between the stop position and the target position exceeds the threshold value (S41: YES), the CPU 91 causes the moving mechanism 30 to move the head 10 to the target position (S24), and then returns to process in step S12.

As described above, in this embodiment, the predetermined condition is that the distance between the stop position and the target position does not exceed the threshold value. In the case where the distance exceeds the threshold value, the range in which ink is ejected in the acceleration section is large, and the deterioration of image quality can be significant. Therefore, in the case where the distance exceeds the threshold value (S41: YES), the CPU 91 moves the head 10 to the target position and then starts the second movement, that is, after step S24. At the same time, the CPU 91 causes the head 10 to eject ink in the constant speed section (S12). This controls the deterioration of image quality.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

It is not necessary for the liquid to be ejected during movement. For example, after the first movement, which does not involve the ejection of liquid, has been executed in the movement process, the CPU 91 may determine the stop position of the first movement in the first determination process.

In the above-mentioned embodiment, the same type of liquid (black ink) is ejected from the plurality of nozzles contained in the head. However, the present disclosure is not limited to this. For example, the plurality of nozzles contained in the head may eject liquids of mutually different types (colors). The head is not limited to a serial type, and may be a line type.

The recording medium is not limited to paper, and may be cloth, resin components, etc.

The liquid ejecting apparatus according to the present disclosure is not limited to printers, and may also be facsimiles, copy machines, multifunction peripherals, etc.

The program according to the present disclosure can be distributed by recording it on a removable recording medium such as a flexible disk or a fixed recording medium such as a hard disk, or it can be distributed via a communication line.

What is claimed is:

1. A liquid ejecting apparatus comprising:
a head including a nozzle;
a moving mechanism configured to perform a first movement that moves the head from one side of a scanning direction to another side of the scanning direction, and a second movement that moves the head from the another side of the scanning direction to the one side of the scanning direction; and
a controller, wherein
the first movement and the second movement each include moving the head over an acceleration section in which the speed of the head increases from zero to a predetermined speed, a constant speed section in which the speed of the head is maintained at the predetermined speed after the acceleration section, and a deceleration section in which the speed of the head decreases from the predetermined speed to zero after the constant speed section, and
the controller is configured to execute:
causing the moving mechanism to perform the first movement;
determining whether or not a stop position where the head stops at an end of the deceleration section in the first movement is on the one side of the scanning direction relative to a target position;
causing the moving mechanism to execute the second movement and, in the second movement, causing the head to not eject liquid from the nozzle in the acceleration section and to eject the liquid from the nozzle in the constant speed section, in a case where it is determined that the stop position is not on the one side of the scanning direction relative to the target position; and
causing the moving mechanism to execute the second movement and, in the second movement, causing the head to eject the liquid from the nozzle in the acceleration section and the constant speed section, in a case where it is determined that the stop position is on the one side of the scanning direction relative to the target position.

2. The liquid ejecting apparatus according to claim 1, wherein
the controller is configured to execute:
generating ejection data for ejecting the liquid from the nozzle based on image data; and
in the acceleration section and the constant speed section of the second movement, before causing the head to eject the liquid from the nozzle, correcting the ejection data in the acceleration section of the second movement in a direction where a landing position of the liquid ejected from the nozzle is equidistant in the scanning direction, according to the difference between the speed of the head in the acceleration section of the second movement and the predetermined speed.

3. The liquid ejecting apparatus according to claim 1, wherein
the controller is configured to execute not causing the head to eject the liquid from the nozzle in the deceleration section during the second movement in either of case where it is determined that the stop position is not on the one side of the scanning direction relative to the target position, or where it is determined that the stop position is on the one side of the scanning direction relative to the target position.

4. The liquid ejecting apparatus according to claim 1, wherein
the controller is configured to execute:
determining whether or not a predetermined condition is satisfied in a case where it is determined that the stop position is on the one side of the scanning direction relative to the target position; and
causing the moving mechanism to perform the second movement, and causing the head to eject the liquid from the nozzle in the acceleration section and the constant speed section during the second movement, in a case where it is determined that the predetermined condition is satisfied.

5. The liquid ejecting apparatus according to claim 4, wherein
in a case where it is determined that the predetermined condition is not satisfied, the controller is configured to execute causing the moving mechanism to move the head to the target position, and then causing the moving mechanism to execute the second movement, and in the second movement, causing the head to not eject the liquid from the nozzle in the acceleration section, and causing the head to eject the liquid from the nozzle in the constant speed section.

6. The liquid ejecting apparatus according to claim 4, wherein
the predetermined condition is that the number of times it is determined that the stop position is on the one side of the scanning direction relative to the target position exceeds a predetermined number (a natural number).

7. The liquid ejecting apparatus according to claim 4, wherein
the controller is configured to execute accepting either a first instruction from a user or a second instruction from the user that is different from the first instruction, and
the predetermined condition is that the first instruction has been accepted.

8. The liquid ejecting apparatus according to claim 4, wherein
the predetermined condition is that a distance between the stop position and the target position does not exceed a threshold value.

9. A controller configured to control a liquid ejecting apparatus, comprising:
a processor, wherein
the liquid ejecting apparatus including:
a head including a nozzle;
a moving mechanism configured to perform a first movement that moves the head from one side of a scanning direction to another side of the scanning direction, and a second movement that moves the head from the another side of the scanning direction to the one side of the scanning direction,
the first movement and the second movement each include moving the head over an acceleration section in which the speed of the head increases from zero to a predetermined speed, a constant speed section in which the speed of the head is maintained at the predetermined speed after the acceleration section, and a deceleration section in which the speed of the head decreases from the predetermined speed to zero after the constant speed section,
the processor is configured to execute:
causing the moving mechanism to perform the first movement;
determining whether or not a stop position where the head stops at an end of the deceleration section in the first movement is on the one side of the scanning direction relative to the target position;
causing the moving mechanism to execute the second movement and, in the second movement, causing the head to not eject liquid from the nozzle in the acceleration section and to eject the liquid from the nozzle in the constant speed section, in a case where it is determined that the stop position is not on the one side of the scanning direction relative to the target position; and
causing the moving mechanism to execute the second movement and, in the second movement, and causing the head to eject the liquid from the nozzle in the acceleration section and the constant speed section, in a case where it is determined that the stop position is on the one side of the scanning direction relative to the target position.

10. A control method for controlling a liquid ejecting apparatus including:
a head including a nozzle;
a moving mechanism configured to perform a first movement that moves the head from one side of a scanning direction to another side of the scanning direction, and a second movement that moves the head from the another side of the scanning direction to the one side of the scanning direction, wherein
the first movement and the second movement each include moving the head over an acceleration section in which the speed of the head increases from zero to a predetermined speed, a constant speed section in which the speed of the head is maintained at the predetermined speed after the acceleration section, and a deceleration section in which the speed of the head decreases from the predetermined speed to zero after the constant speed section,
the controlling method includes:
causing the moving mechanism to perform the first movement;
determining whether or not a stop position where the head stops at an end of the deceleration section in the first movement is on the one side of the scanning direction relative to the target position;
causing the moving mechanism to execute the second movement and, in the second movement, causing the head to not eject liquid from the nozzle in the acceleration section and to eject the liquid from the nozzle in the constant speed section, in a case where it is determined that the stop position is not on the one side of the scanning direction relative to the target position; and
causing the moving mechanism to execute the second movement and, in the second movement, and causing the head to eject the liquid from the nozzle in the acceleration section and the constant speed section, in a case where it is determined that the stop position is on the one side of the scanning direction relative to the target position.

11. A non-transitory computer readable medium storing program for controlling a liquid ejecting apparatus including:
a head including a nozzle;
a moving mechanism configured to perform a first movement that moves the head from one side of a scanning direction to another side of the scanning direction, and a second movement that moves the head from the another side of the scanning direction to the one side of the scanning direction, wherein
the first movement and the second movement each include moving the head over an acceleration section in which the speed of the head increases from zero to a predetermined speed, a constant speed section in which the speed of the head is maintained at the predetermined speed after the acceleration section, and a deceleration section in which the speed of the head decreases from the predetermined speed to zero after the constant speed section,
the controlling method includes:
causing the moving mechanism to perform the first movement;
determining whether or not a stop position where the head stops at an end of the deceleration section in the first movement is on the one side of the scanning direction relative to the target position;
causing the moving mechanism to execute the second movement and, in the second movement, causing the head to not eject liquid from the nozzle in the acceleration section and to eject the liquid from the nozzle in the constant speed section, in a case where it is determined that the stop position is not on the one side of the scanning direction relative to the target position; and
causing the moving mechanism to execute the second movement and, in the second movement, and causing the head to eject the liquid from the nozzle in the acceleration section and the constant speed section, in a case where it is determined that the stop position is on the one side of the scanning direction relative to the target position.
